(19) United States
(12) Patent Application Publication
(10) Pub. No.: US 2026/0277137 A1
(43) Pub. Date: Sep. 17, 2026

(54) DEVELOPING DEVICE AND IMAGE FORMING APPARATUS

(71) Applicants: Hiroki Miyata, Kanagawa (JP); Yuuki Tsuchiya, Kanagawa (JP); Yuta Yabuta, Kanagawa (JP)

(72) Inventors: Hiroki Miyata, Kanagawa (JP); Yuuki Tsuchiya, Kanagawa (JP); Yuta Yabuta, Kanagawa (JP)

(73) Assignee: Ricoh Company, Ltd., Tokyo (JP)

(21) Appl. No.: 19/560,291

(22) Filed: Mar. 9, 2026

(30) Foreign Application Priority Data
Mar. 13, 2025 (JP) 2025-040393

(51) Int. Cl. G03G 15/09; G03G 15/08

(52) U.S. Cl. CPC G03G 15/0921; G03G 15/0891; G03G 15/0942; G03G 2215/0609

(57) ABSTRACT

A developing device includes a developer container, a developer bearer, a restrictor, and a magnetic member. The developer container contains developer containing toner and magnetic carrier. The developer bearer has a scooping magnetic pole having a magnetic flux density in a normal direction of a normal line normal to the developer bearer, scoops the developer from the developer container, bears the developer scooped from the developer container, and conveys the developer to a developing region. The restrictor restricts thickness of the developer borne on the bearing surface and conveyed to the developing region. The magnetic member has a magnetic face and is disposed on an upstream of the restrictor. The developer bearer has the magnetic flux density that is maximum at a maximum point on the bearing surface by the scooping magnetic pole. The magnetic member has an upstream end disposed downstream of the normal line at the maximum point.

### CROSS-REFERENCE TO RELATED APPLICATION

This patent application is based on and claims priority pursuant to 35 U.S.C. § 119(a) to Japanese Patent Application No. 2025-040393, filed on Mar. 13, 2025, in the Japan Patent Office, the entire disclosure of which is hereby incorporated by reference herein.

### BACKGROUND

### Technical Field

The present disclosure relates to a developing device and an image forming apparatus incorporating the developing device.

### Related Art

A developing device is known that scoops up developer containing toner and magnetic carrier from a developer container by a magnetic force of a developer scooping magnetic pole, bears the developer on a surface of a developer bearer, conveys the developer to a developing region, and restricts a layer thickness of the developer by a restrictor.

### SUMMARY

The present disclosure described herein provides a developing device that includes a developer container, a developer bearer, a restrictor, and a magnetic member. The developer container contains developer containing toner and magnetic carrier. The developer bearer has a scooping magnetic pole having a magnetic flux density in a normal direction of a normal line normal to a bearing surface of the developer bearer, scoops the developer from the developer container by a magnetic force of the scooping magnetic pole, bears the developer scooped from the developer container on the bearing surface, and conveys the developer to a developing region in a conveyance direction. The restrictor restricts thickness of the developer borne on the bearing surface and conveyed to the developing region in the conveyance direction. The magnetic member has a magnetic face facing the bearing surface and disposed on an upstream of the restrictor in the conveyance direction. The developer bearer has the magnetic flux density that is maximum at a maximum point on the bearing surface in the normal direction of the normal line by the scooping magnetic pole. The magnetic member has an upstream end disposed downstream of the normal line at the maximum point in the conveyance direction.

The present disclosure described herein also provides an image forming apparatus that includes the developing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a copier serving as an image forming apparatus according to an embodiment of the present disclosure;

FIG. 2 is a view of one of four image forming units in the copier;

FIG. 3 is a diagram illustrating an internal structure of a developing device in the image forming unit;

FIG. 4 is a diagram illustrating a magnetic flux density in a normal direction on a developing roller by five magnetic poles of a magnet roller in the developing device;

FIG. 5 is a diagram illustrating a configuration of a magnetic plate in the developing device;

FIG. 6 is a diagram illustrating a state of scooping up developer of a developing device including the magnetic plate; and

FIG. 7 is a diagram illustrating a state of scooping up a developer of a developing device including a magnetic plate of a comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Identical reference numerals are assigned to identical or equivalent components and a description of those components may be simplified or omitted. As used herein, the singular forms “a,” “an,” and “the” are intended to include the plural forms as well, unless the context clearly indicates otherwise.

A description is given of an embodiment in which a developing device according to an embodiment of present disclosure is applied to a tandem-type color copier (hereinafter, referred to as a copier 500) as an image forming apparatus. The present disclosure is not limited to the present embodiment as long as the present disclosure is an electrophotographic image forming apparatus using a developing device.

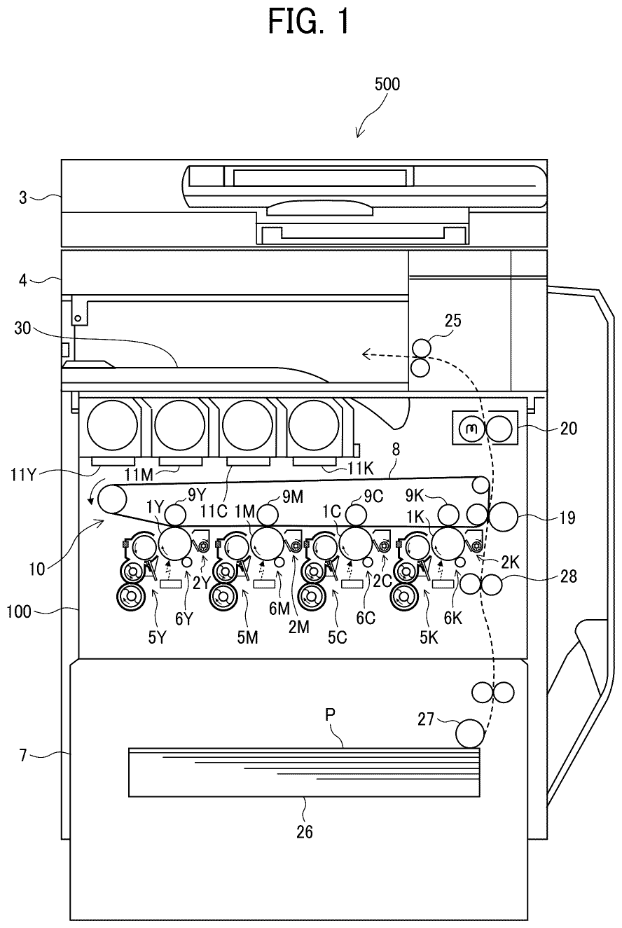

FIG. 1 is a schematic view of a copier 500 according to an embodiment of the present disclosure. The copier 500 according to the present embodiment includes a scanner 4 and a document conveying device 3 above a printer 100, which is a body of the image forming apparatus, and a sheet feeder 7 below the printer 100. The document conveying device 3 conveys a document to the scanner 4, and the scanner 4 reads image data of the conveyed document. The sheet feeder 7 includes a sheet tray 26 in which transfer sheets P as recording media are stored, and a feed roller 27 that feeds the transfer sheets P in the sheet tray 26 toward the printer 100. A dashed line in FIG. 1 indicates a conveyance passage of the transfer sheets P as the recording media in the copier 500.

An upper portion of the printer 100 is a sheet ejection tray 30 on which the transfer sheets P on which output images are formed are stacked. The printer 100 includes four image forming units 6Y, 6M, 6C, and 6K as image formers that form toner images of respective colors (yellow, magenta, cyan, and black), and an intermediate transfer unit 10. The image forming units 6Y, 6M, 6C, and 6K include drum-shaped photoconductors 1Y, 1M, 1C, and 1K as image bearers on which toner images of the respective colors are formed, and developing devices 5Y, 5M, 5C, and 5K that develop electrostatic latent images formed on the surfaces of the photoconductors 1Y, 1M, 1C, and 1K, respectively. In addition, each of the image forming units 6Y, 6M, 6C, and 6K includes a photoconductor cleaning device 2, a charging roller 4a, a writing device 4b. In the present embodiment, the photoconductor cleaning device 2 cleans the photoconductor by a cleaning blade 2a, and the charging roller 4a charges the photoconductor by the charging roller 4a.

The intermediate transfer unit 10 includes an intermediate transfer belt 8 and primary transfer bias rollers 9Y, 9M, 9C, and 9K. The intermediate transfer belt 8 is an intermediate transferor on which the toner images of the respective colors formed on the surfaces of the respective photoconductors 1Y, 1M, 1C, and 1K are transferred in a superimposed manner, and color toner images are formed on the surfaces of the intermediate transfer belt 8. The primary transfer bias rollers 9Y, 9M, 9C, and 9K are primary transferor that transfer the toner images formed on the surfaces of the photoconductors 1Y, 1M, 1C, and 1K to the intermediate transfer belt 8.

The printer 100 includes a secondary transfer bias roller 19 for transferring the color toner image on the intermediate transfer belt 8 onto the transfer sheet P. A registration roller pair 28 adjusts a timing of conveying the transfer sheet P fed by the feed roller 27 to a secondary transfer nip where the intermediate transfer belt 8 and the secondary transfer bias roller 19 face each other. The printer 100 includes a fixing device 20 above the secondary transfer nip. The fixing device 20 fixes unfixed toner image on the transfer sheet P.

Toner containers 11Y, 11M, 11C, and 11K for the respective colors are arranged below the sheet ejection tray 30 in the printer 100 and above the intermediate transfer unit 10. The toner containers 11Y, 11M, 11C, and 11K for the respective colors store toners of the respective colors (yellow, magenta, cyan, and black) to be supplied to the developing devices 5Y, 5M, 5C, and 5K, respectively.

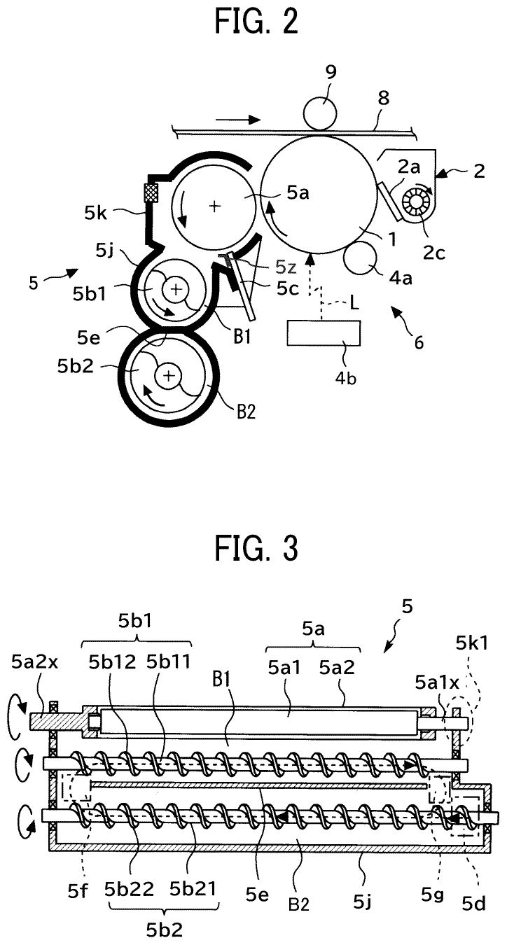

FIG. 2 is a diagram illustrating one of the four image forming units 6Y, 6M, 6C, and 6K in the present embodiment. FIG. 3 is a diagram illustrating an internal structure of the developing device 5 in the present embodiment. The four image forming units 6Y, 6M, 6C, and 6K have substantially the same configuration and operation except that the colors of the toners used in the image forming process are different, and thus, in the following description, the reference numerals Y, M, C, and K indicating the corresponding colors are omitted as appropriate.

The developing device 5 includes a developing roller 5a as a developer bearer facing the photoconductor 1, a first conveying screw 5b1 as a supplier and a conveyer, a second conveying screw 5b2 as a conveyer, a partition 5e, a doctor blade 5c as a restrictor, and a magnetic plate 5z as a magnetic member. A developing-region entrance seal for preventing toner scattering may be disposed between a doctoring portion where the doctor blade 5c faces the developing roller 5a, and the developing region.

The first conveying screw 5b1 and the second conveying screw 5b2 are screws in which spiral blades 5b12 and 5b22 are disposed on rotation shafts 5b11 and 5b21, and rotate around the rotation shafts to convey the developer in the axial direction of the rotation shafts 5b11 and 5b21. In the space inside a casing 5k of the developing device 5, a first conveyance passage B1 in which the first conveying screw 5b1 is disposed and a second conveying passage B2 in which the second conveying screw 5b2 is disposed are spatially partitioned by the partition 5e. The supplied toner is conveyed by the second conveying screw 5b2 while being stirred with the developer. The developer sufficiently mixed with replenishment toner is delivered to the first conveying screw 5b1 through a delivery portion 5g, and is scooped up to the developing roller 5a by a magnetic force. A toner concentration sensor is disposed on the back surface of the casing 5k forming the second conveyance passage B2, and continuously detects the toner concentration of the developer that passes through the toner concentration sensor.

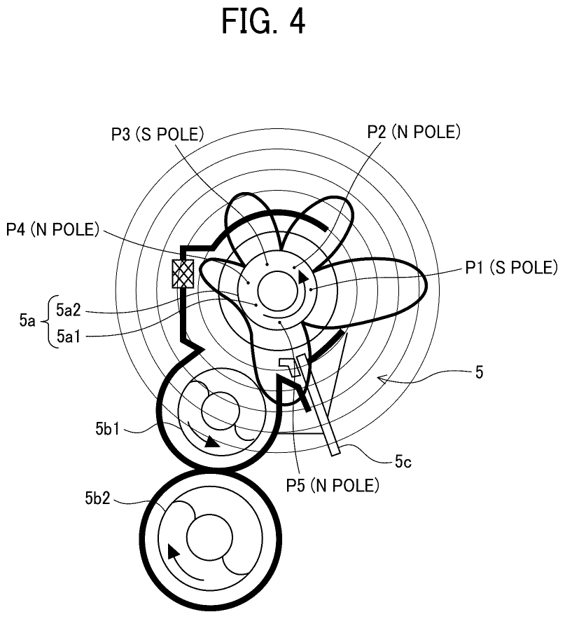

The developing roller 5a includes a magnet roller 5a1 and a developing sleeve 5a2. The magnet roller 5a1 includes a plurality of magnets fixed inside. The developing sleeve 5a2 rotates around the magnet roller 5a1. The developing sleeve 5a2 is a cylindrical member made of a rotatable non-magnetic material and includes the magnet roller 5a1 inside. As illustrated in FIG. 4, the magnet roller 5a1 of the present embodiment includes five magnetic poles, that are, a first magnetic pole P1 (S pole), a second magnetic pole P2 (N pole), a third magnetic pole P3 (S pole), a fourth magnetic pole P4 (N pole), and a fifth magnetic pole P5 (N pole), as the plurality of magnetic poles.

FIG. 4 illustrates the magnetic flux densities in the normal direction on the surface of the developing roller 5a by the five magnetic poles P1 to P5 of the magnet roller 5a1 in the developing device 5 of the present embodiment. However, the magnetic flux densities in the normal direction in FIG. 4 are measured using the developing roller 5a alone, and are in a state where there is no influence of components around the developing roller 5a. The same applies to the magnetic flux density in normal direction in the following description.

Two-component developer (including a case where additives are added) is stored in the casing 5k of the developing device 5, and is circulated and conveyed by the first conveying screw 5b1 and the second conveying screw 5b2. The doctor blade 5c for restricting the thickness of the developer layer on the developing roller 5a is disposed upstream of the developing region, which is the region in which the photoconductor 1 and the developing roller 5a face each other, in the movement direction of the surface of the developing roller 5c (upstream in the conveyance direction of the developer).

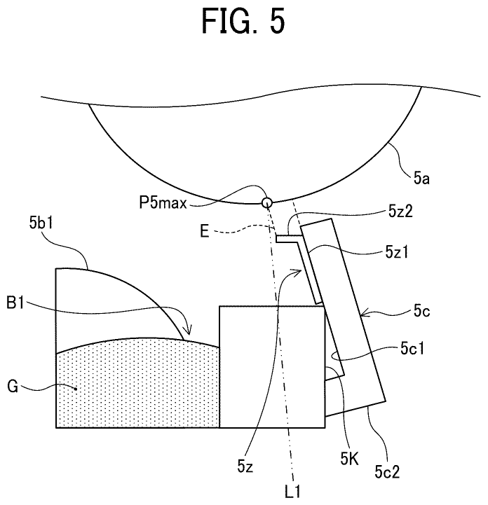

The doctor blade 5c is formed of a plate-shaped member, and is disposed such that one end face of the plate-shaped member faces the surface of the developing roller 5a. The doctor blade 5c preferably has a bent portion 5c2 in which an end face of the plate-shaped member opposite to the one end is bent toward the upstream side (or the downstream side) in the developer conveyance direction (see FIG. 5). According to this configuration, the deflection of the doctor blade 5c due to the pressing of the developer conveyed by the surface movement of the developing roller 5a can be restricted. The deviation in the restricting gap length due to the deflection can be restricted, so that the unevenness and deviation in the amount of the developer conveyed to the developing region can be restricted. The doctor blade 5c is preferably made of iron-containing material such as stainless steel rather than aluminum in terms of cost.

The developing device 5 of the present embodiment is filled with 160 gram of developer in which toner (average particle diameter: 5.2 μm) containing polyester resin as a main component and carrier (average particle diameter: 35 μm) as magnetic fine particles are uniformly mixed so that the toner concentration is 7 wt %. The first conveying screw 5b1 and the second conveying screw 5b2 are disposed in parallel, so that the developer is conveyed and the fresh toner supplied from the toner supply port is stirred at the same time, and the toner and the carrier are uniformly mixed and charged.

The uniformly mixed developer is conveyed in the axial direction of the developing roller 5a by the first conveying screw 5b1 disposed in parallel with and in proximity to the developing roller 5a, and is scooped up to the outer circumferential surface of the developing roller 5a by the magnetic force of the fifth magnetic pole P5 of the magnet roller 5a1 disposed inside the developing roller 5a. The developing roller 5a rotates counterclockwise as indicated by an arrow in FIG. 2, so that the developer scooped up to the developing roller 5a reaches the developing region after the thickness of the developer layer is restricted by the doctor blade 5c.

A voltage is applied from a high-voltage power supply to the developing sleeve 5a2 of the developing roller 5a, and a developing electric field is formed between the developing roller 5a and the photoconductor 1 in the developing region. The developing electric field causes the toner in the developer on the surface of the developing roller 5a to be supplied to the latent electrostatic image on the surface of the photoconductor 1, so that the latent electrostatic image on the photoconductor 1 is developed.

Next, a description is given of the operation of the copier 500 of the present embodiment at the time of normal color image formation. First, when a start button is pressed in a state where a document is set on a document table of the document conveying device 3, conveying rollers of the document conveying device 3 convey a document on the document table onto an exposure glass of the scanner 4. The scanner 4 optically scans the document on the exposure glass to read image data.

Specifically, the scanner 4 irradiates the image of the original document on the exposure glass with light emitted from a light source (e.g., a lamp), thereby scanning the image of the original document. The light reflected from the surface of the document is imaged on a color sensor via mirrors and lenses. The multicolor image data of the document is read for each color separation light of red, green, and blue (RGB) by the color sensor and converted into electrical image signals. Further, the image signals are transmitted to an image processor that performs image processing (e.g., color conversion, color calibration, and spatial frequency adjustment) according to the color separation image signals of RGB, and thus image data of yellow, magenta, cyan, and black are obtained.

The yellow, magenta, cyan, and black image data are transmitted to the writing device 4b. The writing device 4b emits laser beams L (e.g., exposure light) onto the surfaces of the photoconductors 1Y, 1M, 1C, and 1K according to the image data of yellow, magenta, cyan, and black, respectively.

Meanwhile, the four photoconductors 1Y, 1M, 1C, and 1K rotate clockwise as illustrated in FIGS. 1 and 2. First, the charging roller 4a uniformly charges the surface of each of the photoconductors 1Y, 1M, 1C, and 1K at a position at which the surface of each of the photoconductors 1Y, 1M, 1C, and 1K faces the charging roller 4 (a charging process). In this way, the surface of each of the photoconductors 1Y, 1M, 1C, and 1K is set to the target charging potential. Thereafter, the surface of each of the charged photoconductors 1Y, 1M, 1C, and 1K reaches the position irradiated with the laser light L, and the laser light L corresponding to the image signal is emitted by the writing device 4b in correspondence with each color. The respective laser beams L pass through different optical passages for components of yellow, magenta, cyan, and black (an exposure process).

The laser beam L corresponding to the yellow component is emitted to the surface of the leftmost photoconductor 1Y in FIG. 1. A polygon mirror that rotates at high velocity deflects the laser beam L for yellow along the axis of rotation of the photoconductor 1Y for yellow (a main scanning direction) so that the laser beam L scans the surface of the photoconductor 1Y. Thus, an electrostatic latent image for yellow is formed on the surface of the photoconductor 1Y charged by the charging roller 4a.

Similarly, the laser beam L corresponding to the magenta component is emitted to the surface of the second photoconductor 1M from the left in FIG. 1. Thus, an electrostatic latent image corresponding to the magenta component is formed. The laser beam L corresponding to the cyan component is emitted to the surface of the third photoconductor 1C from the left in FIG. 1. Thus, an electrostatic latent image corresponding to the cyan component is formed. The laser beam L corresponding to the black component is emitted to the surface of the fourth photoconductor 1K from the left in FIG. 1. Thus, an electrostatic latent image corresponding to the black component is formed.

Then, the surface of each of the photoconductors 1Y, 1M, 1C, and 1K bearing the electrostatic latent image for each color reaches the position opposite the developing device 5. The developing devices 5Y, 5M, 5C, and 5K supply toner of each color onto the surface of the photoconductors 1Y, 1M, 1C, and 1K, and develop the electrostatic latent image on the photoconductors 1Y, 1M, 1C, and 1K into a toner image, respectively (a development process).

The surfaces of the photoconductors 1Y, 1M, 1C, and 1K after passing through a facing portion facing the developing device 5 reach a facing portion facing the intermediate transfer belt 8. The primary transfer bias rollers 9Y, 9M, 9C, and 9K are disposed at positions where the photoconductor drums 1Y, 1M, 1C, and 1K face the intermediate transfer belt 8 to contact an inner circumferential surface of the intermediate transfer belt 8. The photoconductors 1Y, 1M, 1C, and 1K and the primary transfer bias rollers 9Y, 9M face each other with the intermediate transfer belt 8 interposed therebetween, so that primary transfer nips are formed. Then, at the primary transfer nips, the toner images of the respective colors formed on the respective photoconductors 1Y, 1M, 1C, and 1K are sequentially transferred onto the intermediate transfer belt 8 in a superimposed manner (a primary transfer process).

After the primary transfer process, the surface of each of the photoconductors 1Y, 1M, 1C, and 1K reaches the position opposite the photoconductor cleaning device 2 (see FIG. 2). At a position facing the photoconductor cleaning device 2, the untransferred toner remaining on each of the photoconductors 1Y, 1M, 1C, and 1K is scraped off by the cleaning blade 2a and collected (a photoconductor cleaning process). The surfaces of the photoconductors 1Y, 1M, 1C, and 1K that have passed through the portion facing the photoconductor cleaning device 2 pass through the charge eliminating device to eliminate the residual charge. A series of image forming processes for the photoconductors 1Y, 1M, 1C, and 1K is completed to prepare for the next image forming operation.

On the other hand, the multicolor toner image is formed on the intermediate transfer belt 8 by transferring (bearing) and superimposing the respective single color toner images on the photoconductors 1Y, 1M, 1C, and 1K. Then, the intermediate transfer belt 8 bearing the multicolor toner image moves counterclockwise in FIG. 1 to reach a position opposite the secondary transfer bias roller 19. The feed roller 27 feeds the transfer sheets P from the sheet tray 26 that stores a stack of the transfer sheets P. The sheets P pass through a conveyance guide to be guided by the registration roller pair 28. The transfer sheet P that has contacted the registration roller pair 28 is conveyed toward the secondary transfer nip in accordance with the timing at which the color toner image formed on the intermediate transfer belt 8 is conveyed toward the secondary transfer nip. Then, the color toner image borne on the intermediate transfer belt 8 is transferred onto the transfer sheet P at the secondary transfer nip (a secondary transfer process).

The surface of the intermediate transfer belt 8 that has passed through the secondary transfer nip reaches a portion facing an intermediate-transfer-belt cleaning device. At this opposing portion, the untransferred toner adhered on the intermediary transfer belt 8 is collected by the intermediate-transfer-belt cleaning device, so that a series of transfer processes on the intermediary transfer belt 8 is ended.

The untransferred toner scraped off from the surface of each of the photoconductors 1Y, 1M, 1C, and 1K by the cleaning blade 2a passes through a collected toner conveyance passage 2c, and is stored in a waste-toner container. The untransferred toner and the toner of the pattern image for process control, which are scraped off from the surface of the intermediate transfer belt 8 by the intermediate-transfer-belt cleaning device, are also collected in the waste-toner container.

The transfer sheet P on which the color toner image is transferred at the secondary transfer nip is guided to the fixing device 20. In the fixing device 20, the color image is fixed on the transfer sheet P by heat and pressure at a fixing nip formed by a fixing roller and a pressure roller. The transfer sheets P having passed through the fixing device 20 are ejected as output images to the outside of the printer 100 by a sheet ejection roller pair 25, and are stacked on the sheet ejection tray 30. Thus, a series of image forming processes is completed.

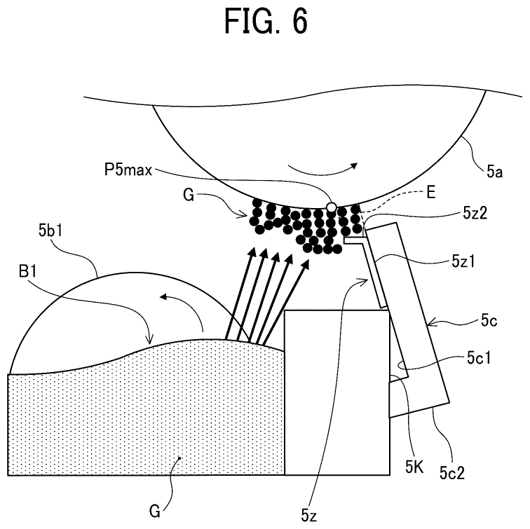

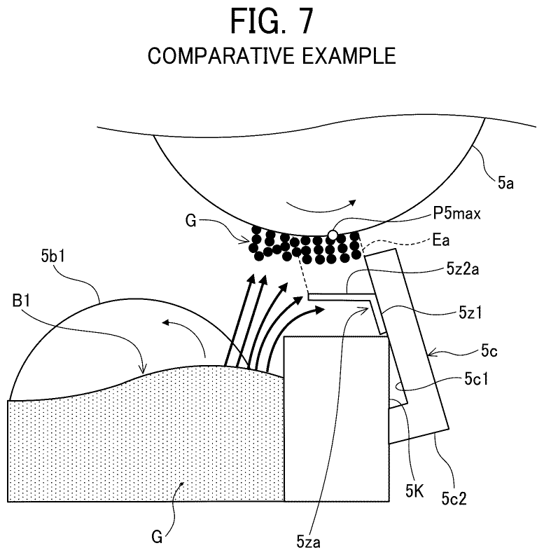

Next, a description is given of the magnetic plate 5z of the developing device 5 in the present embodiment. FIG. 5 is a diagram illustrating a configuration of the magnetic plate 5z in the present embodiment. FIG. 6 is a diagram illustrating a state of scooping up the developer in the developing device 5 including the magnetic plate 5z in the present embodiment. FIG. 7 is a diagram illustrating a state of scooping up the developer in the developing device 5 including a magnetic plate 5za in the comparative example.

The magnetic plate 5z in the present embodiment is attached to an upstream face 5c1 of the doctor blade 5c in the movement direction of the surface of the developing roller 5a (in the conveyance direction of the developer). The magnetic plate 5z includes an attachment face 5z1 arranged along the upstream face 5c1 of the doctor blade 5c, and a magnetic face 5z2 facing the surface of the developing roller 5a on the upstream side of the doctor blade 5c in the developer conveyance direction. The magnetic face 5z2 of the magnetic plate 5z is positioned in the vicinity of the fifth magnetic pole P5 among the five magnetic poles of the magnet roller 5a1 disposed inside the developing roller 5a.

As illustrated in FIG. 6, a part of the developer G in the first conveyance passage B1, which is stirred and mixed by the first conveying screw 5b1, is attracted and scooped to the surface of the developing roller 5a by the magnetic force of the fifth magnetic pole P5 of the magnet roller of the developing roller 5a, and is borne on the surface of the developing roller 5a. The developer G borne on the developing roller 5a passes through a facing area E facing the magnetic face 5z2 of the magnetic plate 5z by the surface movement of the developing roller 5a, and then, the layer thickness of the developer G is restricted by the doctor blade 5c to reach the developing region. In the developing region, the toner in the developer on the surface of the developing roller 5a adheres to the latent electrostatic image on the surface of the photoconductor 1, and the latent electrostatic image is developed.

The developer having a reduced toner concentration after passing through the developing region passes through the vicinity of a magnetic pole P4 by the surface movement of the developing roller 5a, is magnetically separated from the magnetic pole P4 of the developing roller 5a mainly by the action of the magnetic field by the magnetic pole P4, and is returned to the first conveyance passage B1. The returned developer is usually stirred and conveyed by the first conveying screw 5b1 and the second conveying screw 5b2, so that the toner concentration of the developer G is gradually uniformized in the first conveyance passage B1 and the second conveyance passage B2. However, the developer G immediately after being returned is not sufficiently stirred and has an insufficient toner concentration. When the developer G in such a state is scooped up from the first conveying passage B1 to the developing roller 5a, the developer G having an insufficient toner concentration is borne on the developing roller 5a. As a result, the developer G borne on the developing roller 5a is in a state in which unevenness of the toner concentration (toner concentration deviation) occurs. When the developer G in such a state is conveyed to the developing region as it is, an image defect occurs.

In the present embodiment, the magnetic face 5z2 of the magnetic plate 5z is disposed opposite the surface of the developing roller 5a in the vicinity of the fifth magnetic pole P5 in the developing roller 5a on the upstream side of the doctor blade 5c in the conveyance direction of the developer G (in the movement direction of the surface of the developing roller 5a). As a result, the magnetic fluxes are concentrated between the magnetic face 5z2 of the magnetic plate 5z and the fifth magnetic pole P5 in the developing roller 5a, so that a magnetic-flux concentrated region E can be formed on the upstream side of the doctor blade 5c in the developer conveyance direction.

In the magnetic-flux concentrated region E, a part of the developer G borne on the surface of the developing roller 5a remains at a high density. When the developer G scooped up on the developing roller 5a passes through the magnetic-flux concentrated region E, the developer G scooped up on the developing roller 5a is rubbed against the developer G having a high density, so that the toner transfer occurs. As a result, the developer G in which the unevenness of toner concentration occurs passes through the magnetic-flux concentration region E, so that a leveling effect of leveling the unevenness of toner concentration is exhibited, and thus, the unevenness of toner concentration is enhanced. Accordingly, even if the developer G scooped up on the developing roller 5a has the unevenness of toner concentration, the developer G passes through the magnetic-flux concentration region E, so that the unevenness of toner concentration can be enhanced before passing through the doctor blade 5c (before being conveyed to the developing region).

In order to obtain a high leveling effect of the unevenness of toner concentration of the developer G, the length of a magnetic-flux concentration region Ea in the developer conveyance direction is made long in the comparative example. In particular, as in the comparative example illustrated in FIG. 7, the upstream end of the magnetic face 5z2a of the magnetic plate 5za in the developer conveyance direction extends beyond the normal line L1 of the point P5max where the magnetic-flux density in the normal direction by the fifth magnetic pole P5 is the maximum on the surface of the developing roller 5a, and extends to the upstream side of the normal line L1 in the developer conveyance direction. The maximum point P5max of the magnetic-flux density in the normal direction by the fifth magnetic pole P5 is a point where the developer scooping amount scooped from the first conveyance passage B1 to the developing roller 5a is the largest. Accordingly, in the comparative example illustrated in FIG. 7, a part of the flow of the developer G (the flow indicated by the arrow in FIG. 7) scooped up to the point P5max on the developing roller 5a where the amount of the developer G scooped up is the largest is blocked by the magnetic plate 5za, and thus the amount of the developer scooped up becomes insufficient.

In contrast, as illustrated in FIG. 5, in the magnetic plate 5z according to the present embodiment, the upstream end of the magnetic face 5z2 in the developer conveyance direction is located downstream from the normal line L1 of the point P5max at which the magnetic-flux density in the normal direction by the fifth magnetic pole P5 is the maximum on the surface of the developing roller 5a in the developer conveyance direction. According to this configuration, as illustrated in FIG. 6, the flow of the developer G scooped up to the point P5max on the developing roller 5a where the amount of the developer scooped up is the largest is less likely to be blocked by the magnetic plate 5z, and thus the shortage of the amount of the developer scooped up can be restricted.

In the present embodiment, a length of the magnetic face 5z2 in the developer conveyance direction is shorter than the length of the magnetic face 5z2 in the comparative example. For example, the length of the magnetic face 5z2 in the developer conveyance direction in the present embodiment is 1.5 mm or less. For this reason, the length of the magnetic-flux concentration region E between the magnetic face 5z2 and the fifth magnetic pole P5 in the developer conveyance direction is shorter than the length of the magnetic-flux concentration region E in the comparative example. Thus, the effect of leveling the unevenness of toner concentration of the developer G by the magnetic-flux concentration region E may be insufficient.

As a countermeasure against this inconvenience, for example, there may be a method of shifting the position of the doctor blade 5c to the downstream side in the developer conveyance direction, and forming the magnetic plate 5z so that the magnetic face 5z2 has the same length in the developer conveyance direction as that of the comparative example, thereby maintaining the length of the magnetic-flux concentration region E in the developer conveyance direction.

In the case where it is difficult to shift the position of the doctor blade 5c toward the downstream side in the developer conveyance direction, the magnetic plate 5z may be formed such that the distance between the magnetic face 5z2 and the developing roller 5a are smaller than the distance in the comparative example. For example, the distance between the magnetic face 5z2 and the surface of the developing roller 5a are set to 1.2 mm or less. According to this configuration, the magnetic force in the magnetic-flux concentration region E is stronger than the magnetic force in the comparative example. Even in the magnetic-flux concentration region E having a shorter length in the developer conveyance direction than the magnetic force in the comparative example, the effect of leveling the unevenness of the toner concentration close to or equal to the magnetic force in the comparative example can be obtained.

In particular, in the present embodiment, the distance between the magnetic face 5z2 and the surface of the developing roller 5a are set to 1.2 mm or less over the entire region (329 mm) of the magnetic plate 5z in the longitudinal direction (in the axial direction of the developing roller 5a). According to this configuration, the magnetic force in the magnetic-flux concentration region E can be increased over the entire developing effective width, and thus, the effect of leveling the unevenness of the toner concentration over the entire developing effective width can be obtained.

The configurations according to the above-descried embodiments are examples, and embodiments of the present disclosure are not limited to the above. For example, the following aspects can achieve specific effects described below.

### First Aspect

A developing device (e.g., the developing device 5) includes a developer container (e.g., the first conveyance passage B1), a developer bearer (e.g., the developing roller 5a), a restrictor (e.g., the doctor blade 5c), and a magnetic member (e.g., the magnetic plate 5z). The developer container contains developer (e.g., the developer G) containing toner and magnetic carrier. The developer bearer bears the developer scooped from the developer container by a magnetic force of a scooping magnetic pole (e.g., the fifth magnetic pole P5) and conveys the developer to a developing region. The restrictor restricts a thickness of the developer borne on a surface of the developer bearer and conveyed to the developing region. The magnetic member includes a magnetic face (e.g., the magnetic face 5z2) facing the developer bearer at an upstream side of the restrictor in a developer conveyance direction. The magnetic member is formed such that an upstream end of the magnetic face in the developer conveyance direction is positioned on a downstream from a normal line (e.g., the normal line L1) of a point (e.g., the point P5max) where a magnetic flux density in a normal direction is maximum on the surface of the developer bearer. In the developing device in which the magnetic face of the magnetic member is opposed to the surface of the developer bearer on the upstream side of the restrictor with respect to the developer conveyance direction, as described above, the developer passes through the magnetic flux concentration region formed between the magnetic face and the scooping magnetic pole, so that the effect of uniformizing the toner concentration deviation of the developer is obtained. However, in a developing device according to the comparative example, an upstream end of the magnetic face in the developer conveyance direction extends beyond the normal line of the point where the magnetic flux density in the normal direction by the scooping magnetic pole is maximized on the surface of the developer bearer, and extends to the upstream side of the normal line of the point in the developer conveyance direction. The magnetic flux density in the normal direction by the scooping magnetic pole is maximized on the surface of the developer bearer at a point where the amount of developer scooped up from the developer container to the surface of the developer bearer is largest. Accordingly, in the developing device according to the comparative example, the flow of the developer scooped up to the point on the surface of the developer bearer where the developer scooping amount is the largest is hindered by the magnetic member, so that an inconvenience that the developer scooping amount becomes insufficient may occur. In the first aspect, the upstream end of the magnetic face in the developer conveyance direction is located downstream of the normal line of the point where the magnetic flux density in the normal direction by the scooping magnetic pole is maximized on the surface of the developer bearer in the developer conveyance direction. According to this configuration, the flow of the developer scooped up to the point on the surface of the developer bearer where the developer scooping amount is the largest is hindered by the magnetic member, so that the shortage of the developer scooping amount can be restricted. In the first aspect, in a case where the upstream end of the magnetic face in the developer conveyance direction is located downstream of the normal line at the upstream end in the developer conveyance direction, a magnetic flux concentration region formed between the magnetic face and the scooping magnetic pole is narrowed in a configuration in which the length of the magnetic face in the developer conveyance direction is simply shorter than the magnetic flux concentration region in the comparative example. As a result, the above-described effect of leveling the toner concentration deviation of the developer in the magnetic flux concentration region may be insufficient. In this case, it is preferable to enhance the effect of leveling the toner concentration deviation of the developer in the magnetic flux concentration region by, for example, forming the magnetic member, so that the magnetic face has a length in the developer conveyance direction equivalent to that in the comparative example to maintain the width of the magnetic flux concentration region, or forming the magnetic member, so that the magnetic face is closer to the surface of the developer bearer than in the comparative example to increase the strength of the magnetic force in the magnetic flux concentration region.

### Second Aspect

In the developing device (e.g., the developing device 5) according to the first aspect, a distance between the surface of the developer bearer (e.g., the developing roller 5a) and the magnetic face (e.g., the magnetic face 5z2) is 1.2 mm or less. According to this configuration, a distance between the surface of the developer bearer and the magnetic face is reduced to increase the magnetic flux density, so that the effect of leveling the toner concentration deviation of the developer (e.g., the developer G) in the magnetic flux concentration region can be enhanced. As a result, the effect of leveling the toner density deviation close to or equal to the effect in the comparative example can be maintained.

### Third Aspect

In the developing device (e.g., the developing device 5) according to the second aspect, a distance between the surface of the developer bearer (e.g., the developing roller 5a) and the magnetic face (e.g., the magnetic face 5z2) is 1.2 mm or less across an effective development width. According to this configuration, the effect of leveling the toner density deviation can be maintained over the entire developing effective width.

### Fourth Aspect

In the developing device (e.g., the developing device 5) according to any one of the first to third aspects, the magnetic member (e.g., the magnetic plate 5z) is a plate-shaped member that protrudes from an upstream face (e.g., the upstream face 5c1) of the restrictor (e.g., the doctor blade 5c) in the developer conveyance direction toward a downstream side in the developer conveyance direction. According to this configuration, the magnetic member having a simple configuration can be obtained.

### Fifth Aspect

In the developing device (e.g., the developing device 5) according to the fourth aspect, an amount of protrusion of the restrictor (e.g., the doctor blade 5c) from the upstream face of the restrictor in the developer conveyance direction to the downstream side in the developer conveyance direction is 1.5 mm or less. According to this configuration, even in a configuration in which the restrictor is disposed close to the scooping magnetic pole (e.g., the fifth magnetic pole P5), the upstream end of the magnetic face (e.g., the magnetic face 5z2) of the magnetic member (e.g., the magnetic plate 5z) in the developer conveyance direction can be located downstream of the normal line (e.g., the normal line L1) of the point (e.g., the point P5max) where the magnetic-flux density in the normal direction by the scooping magnetic pole is maximized on the surface of the developer bearer (e.g., the developing roller 5a) in the developer conveyance direction. The restrictor is formed to be close to the scooping magnetic pole, so that the layer thickness of the developer (e.g., the developer G) in a high density state can be restricted by the restrictor (e.g., the doctor blade 5c), and thus, the amount of the developer to be fed to the developing region can be restricted with higher accuracy.

### Sixth Aspect

In the developing device (e.g., the developing device 5) according to any one of the first to fifth aspects, the restrictor (e.g., the doctor blade 5c) is made of an iron-containing material (for example, stainless steel). Such a configuration is advantageous in terms of cost compared to a restrictor formed of aluminum.

### Seventh Aspect

In the developing device (e.g., the developing device 5) according to any one of the first to sixth aspects, the restrictor (e.g., the doctor blade 5c) is formed of a plate-shaped member, one end of the plate-shaped member is located to face the surface of the developer bearer (e.g., the developing roller 5a), and another end of the plate-shaped member located on a side opposite to the one end is bent toward an upstream side or a downstream side in the developer conveyance direction. The restrictor is provided with the bent portion (e.g., the bent portion 5c2), so that the bending of the restrictor formed of a plate-shaped member by being pushed by the developer (e.g., the developer G) that is borne on the surface of the developer bearer and is conveyed can be restricted. The deviation of the distance between the restrictor and the surface of the developer bearer is restricted, so that unevenness and deviation of the amount of the developer conveyed to the developing region can be restricted.

### Eighth Aspect

An image forming apparatus (e.g., the copier 500) includes the developing device (e.g., the developing device 5) according to any one of the first to seventh aspects. According to this configuration, in the image forming apparatus including the developing device in which the magnetic face (e.g., the magnetic face 5z2) of the magnetic member (e.g., the magnetic plate 5z) faces the surface of the developer bearer (e.g., the developing roller 5a) on the upstream side of the restrictor (e.g., the doctor blade 5c) in the developer conveyance direction, shortage of the amount of developer (e.g., the developer G) scooped up from the developer container (e.g., the first conveyance passage B1) to the surface of the developer bearer.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A developing device comprising:
a developer container containing developer containing toner and magnetic carrier;
a developer bearer having a scooping magnetic pole having a magnetic flux density in a normal direction of a normal line normal to a bearing surface of the developer bearer to:
scoop the developer from the developer container by a magnetic force of the scooping magnetic pole;
bear the developer scooped from the developer container on the bearing surface; and
convey the developer to a developing region in a conveyance direction;
a restrictor to restrict thickness of the developer:
borne on the bearing surface; and
conveyed to the developing region in the conveyance direction; and
a magnetic member having a magnetic face facing the bearing surface, the magnetic face disposed on an upstream of the restrictor in the conveyance direction,
wherein the developer bearer has the magnetic flux density that is maximum at a maximum point on the bearing surface in the normal direction of the normal line by the scooping magnetic pole, and
the magnetic member has an upstream end disposed downstream of the normal line at the maximum point in the conveyance direction.

2. The developing device according to claim 1,
wherein a distance between the bearing surface of the developer bearer and the magnetic face is 1.2 mm or less in the normal direction.

3. The developing device according to claim 2,
wherein the distance between the surface of the developer bearer and the magnetic face is 1.2 mm in the normal direction across an effective development width of the magnetic member in a longitudinal direction of the magnetic member.

4. The developing device according to claim 1,
wherein the magnetic member includes a magnetic plate protruding from an upstream face of the restrictor toward the normal line, upstream from the restrictor, in the conveyance direction.

5. The developing device according to claim 4,
wherein an amount of protrusion of the magnetic plate in the conveyance direction is 1.5 mm or less.

6. The developing device according to claim 1,
wherein the restrictor is made of an iron-containing material.

7. The developing device according to claim 1,
wherein the restrictor includes a blade having:
one end facing the bearing surface of the developer bearer, and
another end bent toward the normal line in the conveyance direction.

8. An image forming apparatus comprising the developing device according to claim 1.
